(19) United States
(12) Patent Application Publication
(10) Pub. No.: US 2019/0376812 A1
(43) Pub. Date: Dec. 12, 2019

(54) METHOD AND ELECTRONIC DEVICE FOR MANAGING THE DISPLAY OF AN AIRCRAFT FLIGHT PLAN, RELATED COMPUTER PROGRAM AND ELECTRONIC DISPLAY SYSTEM

(71) Applicant: THALES, Courbevoie (FR)

(72) Inventors: Patrick CAZAUX, Merignac (FR); Charlotte DIETRICH, Merignac (FR); Geoffrey NICOLLET, Merignac (FR)

(21) Appl. No.: 16/433,864

(22) Filed: Jun. 6, 2019

(30) Foreign Application Priority Data
Jun. 12, 2018 (FR) 18 00596

(51) Int. Cl. G01C 23/00; G08G 5/00

(52) U.S. Cl. CPC G01C 23/005; G08G 5/0034; G08G 5/0047; G08G 5/0021

(57) ABSTRACT

This method for managing the display of a flight profile of an aircraft is implemented by an electronic management device. It comprises determining a current range of altitudes displayed during the display of a vertical flight profile; and acquiring at least one constraint associated with an upcoming point of a flight plan, each constraint including at least one reference altitude.

The method further comprises, when a respective reference altitude is not included in the current displayed altitude range, displaying a symbol representative of the constraint for said reference altitude not included in the current displayed altitude range.

### CROSS-REFERENCE TO RELATED APPLICATIONS

This application is a U.S. non-provisional application claiming the benefit of French Application No. 18 00596, filed on Jun. 12, 2018, which is incorporated herein by reference in its entirety.

### FIELD

The present invention relates to a method for managing the display of a flight plan of an aircraft, the method being implemented by an electronic display management device.

The invention also relates to a non-transitory computer-readable medium including a computer program including software instructions which, when executed by a computer, implement such a display management method.

The invention also relates to an electronic device for managing the display of a flight plan of an aircraft.

The invention also relates to an electronic system for displaying a flight plan of an aircraft, comprising a display screen and such an electronic display management device configured to manage the display of the flight plan on the display screen.

The invention then relates to the field of man-machine interfaces (MMI) for piloting an aircraft, preferably intended to be installed in an aircraft cockpit.

The invention in particular relates to the display of a flight profile of the aircraft on a display screen. The display of the flight profile is generally separated into 2 separate zones, namely a first zone for displaying a horizontal flight profile, also called navigation display and denoted ND and a second zone for displaying a vertical flight profile, also called vertical display and denoted VD.

The horizontal flight profile is a projection of the flight profile in a horizontal plane, and the vertical flight profile is a projection of the flight profile in a vertical plane, perpendicular to the horizontal plane.

### BACKGROUND

Traditionally, during the use of a device for managing the display of a flight profile of an aircraft, a user, such as a pilot of the aircraft, has the possibility of selecting the display of the flight profile from among at least two display modes, in particular a tracking mode and a flight plan mode.

When the selected mode for the display of the flight profile is the tracking mode, a horizontal axis belonging to said horizontal plane is a straight line passing through the position of the aircraft and extending in a movement direction of the aircraft, or in a direction of extension of the fuselage of the aircraft, or in a direction of a weather radar, or in a specific direction designated by the user.

When the mode selected for the display of the flight profile is the flight plan mode, a horizontal axis is defined by following the segments of the flight plan (straight and curved).

Irrespective of the mode selected from among the tracking mode and the flight plan mode, the vertical reference axis is defined along the axis of the standard barometric or baro-corrected altitudes, corresponding to the QNH aeronautic code.

To display the vertical flight profile in flight plan mode, it is known to display different types of symbols representing different passage altitude constraints of the aircraft, also called navigation altitude constraints, associated with upcoming waypoints of the flight plan.

These navigation altitude constraints are for example an “at or above” altitude, indicating that the aircraft must pass at or above said minimum altitude, an “at or below” altitude indicating that the aircraft must pass at or above said maximum altitude, a predetermined “at” altitude, indicating that the aircraft must pass at said predetermined altitude, and an altitude window indicating that the aircraft must pass in the altitude window, i.e., between the two extreme altitudes defining this altitude window.

The symbols representing these navigation altitude constraints are displayed with the vertical flight profile when the reference altitudes associated with these constraints belong to a current altitude range displayed during the display of the vertical flight profile, i.e., the range of altitudes visible by the user during the display of the vertical flight profile.

Documents U.S. Pat. No. 5,445,021 A and US 2006/0004496 A1 describe such a method for managing the display of the flight plan of the aircraft, comprising the display of symbols representing different navigation altitude constraints. The symbol associated with the at or above constraint is in the form of a triangle with a tip pointing upward, that associated with the at or below constraint is in the form of a triangle with a tip pointing downward, that associated with the at constraint is in the form of two triangles head to tail with the tips in contact with one another, and that associated with the window constraint is in the form of two triangles head to tail with the tips oriented away from one another.

However, such a method for managing the display of the flight plan of the aircraft is not optimal.

### SUMMARY

The aim of the invention is then to propose a method and an electronic device for managing the display of a flight plan of an aircraft making it possible to provide the user, such as the pilot of the aircraft, with more information relative to the flight plan.

To that end, the invention relates to a method for managing the display of a flight plan of an aircraft, the method being implemented by an electronic display management device and comprising the following steps:
determining a current range of altitudes displayed when displaying a vertical flight profile;
acquiring at least one constraint associated with an upcoming point of a flight plan, each constraint including at least one reference altitude;
when a respective reference altitude is not included in the current displayed altitude range, displaying a symbol representative of the constraint for said reference altitude not included in the current displayed altitude range.

With the management method of the state of the art, the visible zone of the vertical display VD is limited by the selected range of visible altitudes. Certain parts of the flight plan and the constraints associated therewith can then be hidden. The display of the flight plan is therefore incomplete, and the operational consequences are numerous, in particular: incomplete awareness of the situation by the pilot relative to the actual situation; delayed detection of the constraint by the pilot; reduced available time for the pilot to understand and process this information, leading to increased workload required; and increased risk of missing a constraint, which may have consequences on flight safety.

With the management method according to the invention, due to the display of a symbol representative of the constraint when a reference altitude associated with the constraint is not included in the current displayed altitude range, the information relative to the constraint(s) is available continuously. The user then does not need to modify his settings, in particular the range of displayed altitudes, in order to view the constraints.

According to other advantageous aspects of the invention, the display management method comprises one or more of the following features, considered alone or according to all technically possible combinations:
during the acquisition step, at least one constraint, preferably each constraint, is a passage altitude constraint of the aircraft;
each constraint is chosen from the group consisting of: an at or above altitude, an at or below altitude, an at altitude and an altitude window;
the symbol further includes additional signage representative of a prediction for realization of the constraint by the aircraft;
when the respective reference altitude is not included in the current displayed altitude range:
   if the respective reference altitude is above the current displayed altitude range, the symbol has a first shape; and
   if the respective reference altitude is below the current displayed altitude range, the symbol has a second shape, different from the first shape;
during the display step, the symbol is displayed in the position of the constraint associated with said reference altitude not included in the current displayed altitude range;
during the display step:
   if the respective reference altitude is above the current displayed altitude range, the symbol is displayed at the maximum altitude of the current displayed altitude range; and
   if the respective reference altitude is below the current displayed altitude range, the symbol is displayed at the minimum altitude of the current displayed altitude range;
the display step further includes the display of a position scale, at the maximum altitude of the current displayed altitude range;
the displayed symbol is in the shape of a half-disc;
the displayed symbol is in the shape of an empty half-disc, and the additional signage is a filling characteristic of the half-disc; and
the method is implemented during the display of a vertical flight profile in flight plan mode.

The invention also relates to a non-transitory computer-readable medium including a computer program including software instructions which, when executed by a computer, implement a display management method, as defined above.

The invention also relates to an electronic display management device configured to manage the display of a flight plan of an aircraft, comprising:
a determining module configured to determine a current range of altitudes displayed when displaying a vertical flight profile;
an acquisition module configured to acquire at least one constraint associated with an upcoming point of a flight plan, each constraint including at least one reference altitude;
a display module configured, when a respective reference altitude is not included in the current displayed altitude range, to display a symbol representative of the constraint for said reference altitude not included in the current displayed altitude range.

The invention also relates to an electronic system for displaying a flight plan of an aircraft, the system comprising a display screen and such an electronic display management device configured to manage the display of the flight plan on the display screen, the electronic display management device being as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic view of an electronic display system according to the invention, configured to display a flight profile of an aircraft;

FIG. 2 is a schematic illustration of a range of altitudes and a range of positions, for the display of the vertical profile by the system of FIG. 1,

FIG. 3 is a view illustrating the flight profile on the screen of the display system, the display being separated into two separate zones with a first zone for displaying a horizontal flight profile, also called navigation display and denoted ND and a second zone for displaying a vertical flight profile, also called vertical display and denoted VD,

FIGS. 4 and 5 are views of the vertical flight profile, displayed on the vertical display VD in flight plan mode and according to the invention,

FIG. 6 is a flowchart of a method, according to the invention, for managing the display of the flight profile of the aircraft,

FIG. 7 is a schematic illustration of first constraint symbols, displayed when the reference altitude(s) associated with the respective constraint(s) belong to the current range of displayed altitude(s),

FIG. 8 is a schematic illustration of second constraint symbols for three first constraints, displayed when the reference altitude(s) associated with the respective constraint are above the current range of displayed altitude(s),

FIG. 9 is a view similar to that of FIG. 8, in the case where the reference altitude(s) associated with the respective constraint are above the current range of displayed altitude(s),

FIG. 10 is a schematic illustration of second constraint symbols for a fourth constraint, displayed when the reference altitude(s) associated with said constraint are above or below the current range of displayed altitude(s), and

FIG. 11 is a schematic illustration of second symbols further including additional signage representative of a prediction for realization of the constraint.

### DETAILED DESCRIPTION

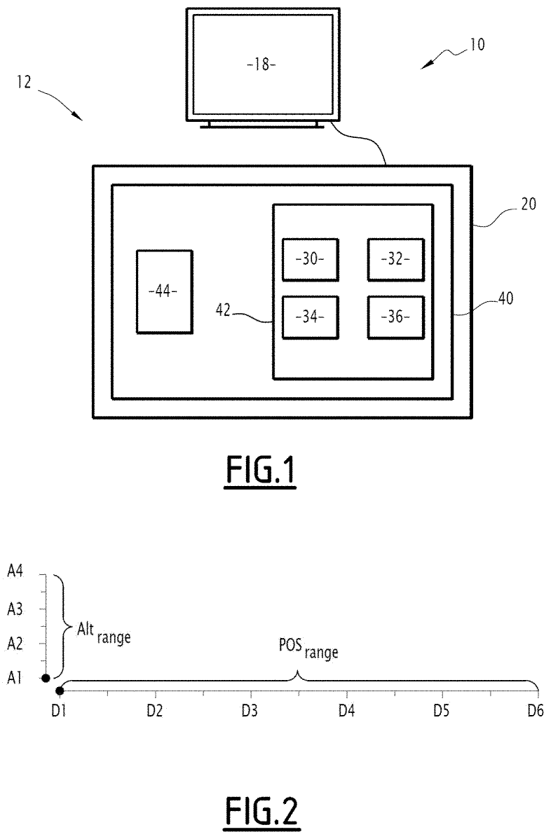

In FIG. 1, an electronic display system 10 is configured to display at least one flight profile of an aircraft 12, namely a vertical flight profile 14 and/or a horizontal flight profile 16.

The electronic display system 10 comprises a display screen 18 and an electronic management device 20 that is configured to manage the display of at least one flight profile 14, 16 on the display screen 18, the management device 20 being connected to the display screen 18.

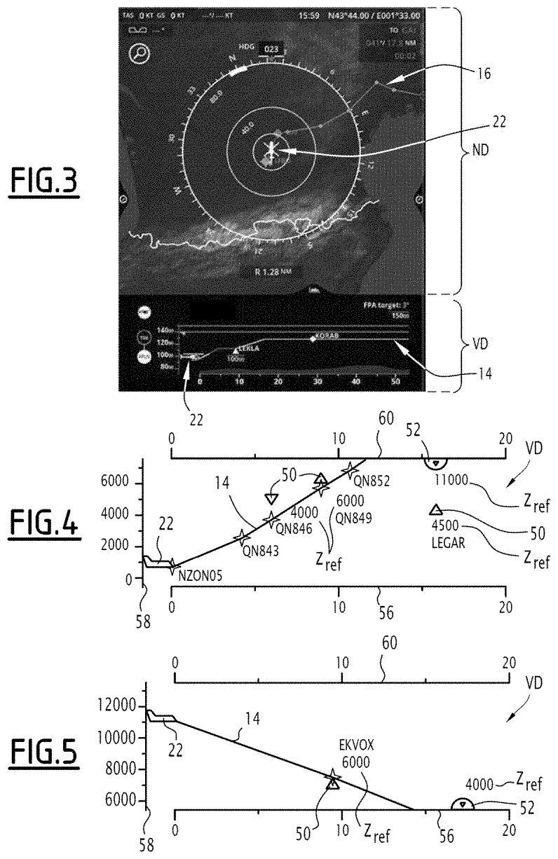

The aircraft 12 is for example an airplane, as shown in FIGS. 4 and 5, where an aircraft symbol 22 depicting the aircraft 12 is in the shape of an airplane. In a variant, the aircraft 12 is a helicopter, like in the example of FIG. 3, for which the aircraft symbol 22 is in the shape of a helicopter. Also in a variant, the aircraft 12 is a drone piloted remotely by a pilot.

The flight profile of the aircraft 12 is known per se, and corresponds to an estimate of the trajectory that the aircraft 12 will follow during its flight.

The vertical flight profile 14 is known per se, and is a projection of the flight profile of the aircraft 12 in a vertical plane containing a vertical reference axis and a horizontal reference axis. The vertical reference axis is defined along the axis of the standard barometric or baro-corrected altitudes, corresponding to the QNH aeronautic code.

The horizontal profile 16 is also known per se, and is a projection of the flight profile of the aircraft 12 in a horizontal plane perpendicular to the vertical plane.

As known per se, during the use of the management device 20, the user, such as a pilot of the aircraft 12, has the possibility of selecting the display of the flight profile from among at least two display modes, in particular a tracking mode and a flight plan mode.

When the mode selected for the display of the flight profile is the tracking mode, the horizontal plane used for the projection of the horizontal profile 16 comprises the horizontal reference axis, which is a straight line passing through the position of the aircraft 12 and extending along a characteristic direction of the aircraft 12, such as its movement direction, the direction of extension of its fuselage, the direction of a weather radar of the aircraft 12, or a specific direction designated by the user.

When the selected display mode is the flight plan mode, the horizontal reference axis is defined by following the segments of the flight plan, straight and curved.

The invention then more particularly relates to the display of the vertical flight profile 14 in flight plan mode.

The electronic management device 20 comprises a determining module 30 configured to determine a current range Alt_{range} of altitudes displayed when displaying the vertical flight profile 14, shown in FIG. 2, said current being also called current displayed altitude range.

The electronic management device 20 comprises an acquisition module 32 configured to acquire at least one constraint C1, C2, C3, C4 associated with an upcoming point of a flight plan, each constraint C1, C2, C3, C4 including at least one reference altitude Z_{ref}.

The electronic management device 20 comprises a test module 34 configured to test whether the reference altitude(s) associated with a respective constraint C1, C2, C3, C4 are included in the current displayed altitude range Alt_{range}, i.e., whether they belong the current displayed altitude range Alt_{range}.

The management device 20 further comprises a display module 36 configured to command the display of the flight profile, in particular the vertical profile 14, on the display screen 18.

In the example of FIG. 1, the electronic management device 20 comprises an information processing unit 40, for example made up of a memory 42 and a processor 44 associated with the memory 42.

In the example of FIG. 1, the determining module 30, the acquisition module 32, the test module 34 and the display module 36 are each made in the form of software, or add-on software, executable by the processor 44. The memory 42 of the electronic management device 20 is then capable of storing determining software configured to determine the current displayed altitude range Alt_{range} during the display of the vertical flight profile 14, acquisition software configured to acquire at least one constraint C1, C2, C3, C4 associated with an upcoming point of the flight plan, test software configured to test whether the reference altitude(s) associated with a respective constraint C1, C2, C3, C4 are included in the current displayed altitude range Alt_{range}, and display software configured to command the display of the flight profile, in particular the vertical profile 14, on the display screen 18. The processor 44 is then capable of executing each of the software applications from among the determining software, the acquisition software, the test software and the display software.

In an alternative that is not shown, the determining module 30, the acquisition module 32, the test module 34 and the display module 36 are each made in the form of a programmable logic component, such as an FPGA (Field Programmable Gate Array), or in the form of a dedicated integrated circuit, such as an ASIC (Applications Specific Integrated Circuit).

When the electronic management device 20 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The determining module 30 is configured to determine the current displayed altitude range Alt_{range} and, as an optional addition, a range of positions Pos_{range} when displaying the vertical flight profile 14, shown in FIG. 2.

The altitude range Alt_{range} thus determined, shown in FIG. 2, is then the altitude range visible when the vertical profile 14 is displayed. In other words, during the display of said vertical profile 14, the displayed portion of the vertical profile 14 is that for the altitudes belonging to the altitude range Alt_{range} thus determined.

One skilled in the art will understand that said altitude range Alt_{range} is then a range of values along the vertical reference axis, corresponding to the set of values capable of being displayed along said vertical axis at the considered moment in time.

As an optional addition, the range of positions Pos_{range} thus determined is then the range of positions visible when the vertical profile 14 is displayed. In other words, during the display of said vertical profile 14, the displayed portion of the vertical profile 14 is that for the positions belonging to the range of positions Pos_{range} thus determined.

One skilled in the art will similarly understand that said range of positions Pos_{range} is then a range of values along the horizontal reference axis, corresponding to the set of values capable of being displayed along said horizontal axis at the considered moment in time.

The acquisition module 32 is configured to acquire at least one constraint C1, C2, C3, C4 associated with an upcoming point of a flight plan.

At least one constraint C1, C2, C3, C4 is a passage altitude constraint of the aircraft 12, also called navigation altitude constraint. Each constraint C1, C2, C3, C4 is a passage altitude constraint of the aircraft 12.

Each constraint is chosen from among a first constraint C1 defining an at or above altitude, a second constraint C2 defining an at or below altitude, a third constraint C3 defining an at altitude and a fourth constraint C4 defining an altitude window.

The first constraint C1, also called at or above, then indicates that the aircraft 12 must pass at or above the minimum altitude, and the reference altitude Z_{ref} associated with the first constraint C1 is then said minimum altitude.

The second constraint C2, also called at or below, then indicates that the aircraft 12 must pass at or below the maximum altitude, and the reference altitude Z_{ref} associated with the second constraint C2 is then said maximum altitude.

The third constraint C3, also called at, then indicates that the aircraft 12 must pass at the predetermined altitude, and the reference altitude Z_{ref} associated with the third constraint C3 is then said predetermined altitude.

The fourth constraint C4, also called window, lastly indicates that the aircraft 12 must pass within the altitude window, i.e., between the two extreme altitudes defining this altitude window. Two reference altitudes Z_{ref} are then associated with the fourth constraint C4, namely the two extreme altitudes defining this altitude window, i.e., the minimum altitude and the maximum altitude of this altitude window, respectively corresponding to the lower and upper bounds of said window.

The test module 34 is configured to test whether the reference altitude(s) associated with a respective constraint C1, C2, C3, C4 are included in the current displayed altitude range Alt_{range}.

The test module 34 is for example configured to compare the reference altitude(s) associated with a respective constraint C1, C2, C3, C4 with the two extreme altitudes defining the current displayed altitude range Alt_{range}, i.e., the minimum altitude and the maximum altitude of this current displayed altitude range Alt_{range}, respectively corresponding to the lower and upper bounds of said current range Alt_{range}.

If the tested reference altitude Z_{ref} is above the upper bound of the current displayed altitude range Alt_{range}, i.e., greater than the maximum altitude of this current displayed altitude range Alt_{range}, or if the tested reference altitude Z_{ref} is below the lower bound of the current range of tested altitudes Alt_{range}, i.e., below the minimum altitude of this current displayed altitude range Alt_{range}, then the test module 34 is configured to deduce therefrom that the tested reference altitude Z_{ref} is not included in said current range of tested altitudes Alt_{range}.

More specifically, if the tested reference altitude Z_{ref} is above the upper bound of the current displayed altitude range Alt_{range}, then the test module 34 is configured to deduce therefrom that the tested reference altitude Z_{ref} is above said current displayed altitude range Alt_{range}, i.e., above said current range. If the tested reference altitude Z_{ref} is below the lower bound of the current displayed altitude range Alt_{range}, then the test module 34 is configured to deduce therefrom that the tested reference altitude Z_{ref} is below said current displayed altitude range Alt_{range}, i.e., below said current range.

In a complementary manner, if the tested reference altitude Z_{ref} is between the lower bound and the upper bound of the current displayed altitude range Alt_{range}, i.e., greater than the minimum altitude and less than the maximum altitude of this current displayed altitude range Alt_{range}, then the test module 34 is configured to deduce therefrom that the tested reference altitude Z_{ref} is included in said current range of tested altitudes Alt_{range}.

The display module 36 is configured to command the display of the vertical profile 14 on the display screen 18.

The display module 36 is in particular configured, when a respective reference altitude Z_{ref} is included in the current displayed altitude range Alt_{range}, to display a first symbol 50 representative of the constraint C1, C2, C3, C4 for said reference altitude Z_{ref} included in the current displayed altitude range Alt_{range}.

According to the invention, the display module 36 is also in particular configured, when a respective reference altitude Z_{ref} is not included in the current displayed altitude range Alt_{range}, to display a second symbol 52 representative of the constraint C1, C2, C3, C4 for said reference altitude Z_{ref} not included in the current displayed altitude range Alt_{range}. The second symbol 52 is preferably different from the first symbol 50, for example a different shape.

As an optional addition, the display module 36 is also configured to display the second symbol 52 with a first shape if the respective reference altitude Z_{ref} is above the current displayed altitude range Alt_{range}, and respectively with a second shape, different from the first shape, if the respective reference altitude Z_{ref} is below the current displayed altitude range Alt_{range}.

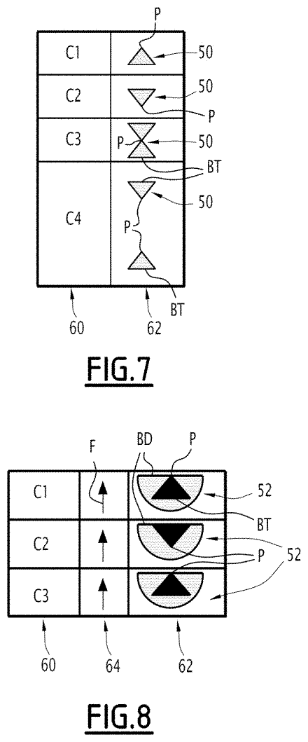

FIG. 7 shows examples of the first symbol 50 as a function of the type of constraint from among the first C1, second C2, third C3 and fourth C4 constraints. These examples are illustrated in the form of a table where a first column 60 contains each respective constraint C1, C2, C3, C4 and a second column 62 contains each corresponding first symbol 50.

These examples of the first symbol 50 are known per se as previously indicated. The first symbol 50 associated with the first constraint C1 of the at or above altitude type is in the shape of a triangle with a tip oriented upward. The first symbol 50 associated with a second constraint C2 of the at or below altitude type is in the shape of a triangle with the tip P oriented downward. The first symbol 50 associated with the third constraint C3 of the at altitude type is in the shape of two triangles head to tail with the tips P in contact with one another and the bases BT of the triangles oriented in opposite directions. Lastly, the first symbol 50 associated with the fourth constraint C4 of the altitude window type is in the shape of two triangles head to tail with the tips P pointed away from one another.

FIGS. 8 to 10 show examples of the second symbol 52 as a function of the type of constraint from among the first C1, second C2, third C3 and fourth C4 constraints. These examples are illustrated each time in the form of a table where the first column 60 contains each respective constraint C1, C2, C3, C4, the second column 62 contains each corresponding second symbol 52, and a third column 66 contains one or several arrows F, each indicating the type of non-inclusion of the respective reference altitude Z_{ref} relative to the current displayed altitude range Alt_{range}. More specifically, if the respective reference altitude Z_{ref} is above the current displayed altitude range Alt_{range}, then the third column 66 contains, for the corresponding case, an arrow F oriented upward, and conversely if the respective reference altitude Z_{ref} is below said current displayed altitude range Alt_{range}, then the third column 66 contains, for the corresponding case, an arrow F oriented downward.

In the examples of FIGS. 8 to 10, each second symbol 52 is then a combination of the shape of the first symbol 50 as a function of the type of constraint from among the first C1, second C2, third C3 and fourth C4 constraints and a shape from among the first and second shapes depending on whether the respective reference altitude Z_{ref} is above, and respectively below, the current displayed altitude range Alt_{range}. In the examples of FIGS. 8 to 10, the first shape then corresponds to a half-disc whereof the base BD is oriented upward, while the second shape then corresponds to a half-disc whereof the base BD is oriented downward.

FIG. 8 then illustrates examples of the second symbol 52 as a function of the type of constraint from among the first C1, second C2 and third C3 constraints, while the corresponding constraint is too high relative to the current displayed altitude range Alt_{range}, i.e., the respective reference altitude Z_{ref} associated with the corresponding constraint is above the current displayed altitude range Alt_{range}.

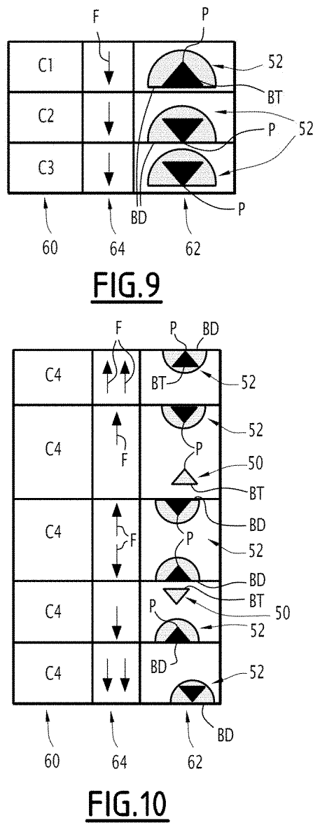

FIG. 9 illustrates examples of the second symbol 52 as a function of the type of constraint from among the first C1, second C2 and third C3 constraints, while the corresponding constraint is too low relative to the current displayed altitude range Alt_{range}, i.e., the respective reference altitude Z_{ref} associated with the corresponding constraint is below the current displayed altitude range Alt_{range}.

FIG. 10 illustrates examples of the second symbol 52 for the fourth constraint C4, which has two reference altitudes Z_{ref}, namely the minimum altitude and the maximum altitude of the altitude window associated with this fourth constraint C4. In the table of FIG. 10, and as shown by the arrows F contained in the third column 64, the first row corresponds to the case where both the minimum altitude and the maximum altitude of the altitude window of the fourth constraint C4 are above the current displayed altitude range Alt_{range} and the last row corresponds to that where both said minimum and maximum altitude are below said current range Alt_{range}.

The second row of this table corresponds to the case where the maximum altitude of the altitude window of the fourth constraint C4 is above the current displayed altitude range Alt_{range} while the minimum altitude is included in said current range and is then represented by the first symbol 50. This second row then corresponds to a case where the fourth constraint C4 is represented in the form of a combination of a first symbol 50 and a second symbol 52. Similarly, the fourth row of this table corresponds to the case where the minimum altitude of the altitude window of the fourth constraint C4 is below the current displayed altitude range Alt_{range} while the maximum altitude is included in said current range and is then represented by the first symbol 50.

Lastly, the third row of this table of FIG. 10 corresponds to the case where the maximum altitude of the altitude window of the fourth constraint C4 is above the current displayed altitude range Alt_{range} while the minimum altitude is below said current range Alt_{range}.

As an optional addition, the display module 36 is further configured to display each symbol from among the first symbol 50 and the second symbol 52 with additional signage 54 representative of a predicted realization of the constraint C1, C2, C3, C4 by the aircraft 12.

The predicted realization of the constraint C1, C2, C3, C4, also called predicted achievement, or proper execution, of the constraint, is for example done by a flight management system (FMS), not shown.

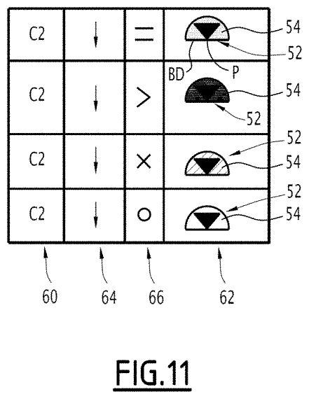

The predicted realization for example has the value ‘Sustained’, symbolized by the ‘=’ sign in the table of FIG. 11, when the flight management system anticipates that the current position of the aircraft 12 and its future dynamics will make it possible to satisfy the constraint C1, C2, C3, C4. The predicted realization for example has the value ‘Active’, symbolized by the ‘>’ sign in the table of FIG. 11, when the constraint C1, C2, C3, C4 is positioned on the next point of the flight plan and the flight management system anticipates that the current position of the aircraft 12 and its future dynamics will make it possible to satisfy the constraint C1, C2, C3, C4. The predicted realization for example has the value ‘Missed’, symbolized by the ‘X’ sign in the table of FIG. 11, when the flight management system anticipates that the current position of the aircraft 12 and its future dynamics will not make it possible to satisfy the constraint C1, C2, C3, C4; and the value ‘Ignored’, symbolized by the ‘O’ sign in FIG. 11, when the flight management system considers that the constraint C1, C2, C3, C4 has not been taken into account.

FIG. 11 illustrates examples of the second symbol 52 for the second constraint C2, further with the additional signage 54 representative of the predicted realization of the constraint C2. These examples are illustrated in the form of a table where the first column 60 contains the corresponding constraint, in the case at hand the mention C2 for the second constraint, the second column 62 contains each corresponding second symbol 52, the third column 66 contains the arrow F indicating the type of non-inclusion of the reference altitude Z_{ref} relative to the current displayed altitude range Alt_{range}, and a fourth column 66 contains a sign from among the aforementioned ‘=’, ‘>’, ‘X’ and ‘O’ signs each symbolizing possible values of the predicted realization.

In the example of FIG. 11, the additional signage 54 is then a particular fill of the half-disc corresponding to the first shape or the second shape. For example, in FIG. 11, the ‘Sustained’ value, symbolized by the ‘=’ sign, is represented by a light gray fill, or a small dotted fill; the ‘Active’ value, symbolized by the ‘>’ sign, is represented by a dark gray fill, or a large dotted fill; the ‘Missed’ value, symbolized by the ‘X’ sign, is represented by a crosshatched fill; and the ‘Ignored’ value, symbolized by the ‘O’ sign, is represented by a white fill, or is empty.

One skilled in the art will of course understand that other types of fill are possible as additional signage 54, such as different colors of fill. According to this variant, the ‘Sustained’ value is for example represented by a green fill, the ‘Active’ value by a purple fill, the ‘Missed’ value by an orange fill, and the ‘Ignored’ value by a white fill.

Also as a variant, the additional signage 54 is represented by an additional shape rather than a fill of the first shape or the second shape.

The display module 36 is configured to display the first symbol 50 in the position of the constraint C1, C2, C3, C4 associated with the reference altitude Z_{ref} included in the current displayed altitude range Alt_{range}.

The display module 36 is configured to display the second symbol 52 in the position of the constraint C1, C2, C3, C4 associated with the reference altitude Z_{ref} not included in the current displayed altitude range Alt_{range}.

The display module 36 is configured to display the first symbol 50 at the reference altitude Z_{ref} included in the current displayed altitude range Alt_{range} associated with the corresponding constraint C1, C2, C3, C4.

For the display of the second symbol 52, if the respective reference altitude Z_{ref} is above the current displayed altitude range Alt_{range}, the display module 36 is configured to display the second symbol 52 at the maximum altitude of the current displayed altitude range Alt_{range}. In a complementary manner, if the respective reference altitude Z_{ref} is below the current displayed altitude range Alt_{range}, the display module 36 is configured to display the second symbol 52 at the minimum altitude of the current displayed altitude range Alt_{range}.

The display module 36 is configured to display, at the altitude corresponding to the lower bound of the current displayed altitude range Alt_{range}, a main position scale 56, and to the left of the lower bound of the current range of displayed positions Pos_{range}, an altitude scale 58. In other words, the main position scale 56 is displayed at the minimum altitude of the current displayed altitude range Alt_{range} and the altitude scale 58 is displayed to the left of the minimum position of the current range of displayed positions Pos_{range}. As known per se and shown in FIGS. 4 and 5, the main position scale 56 is a horizontal scale, and the altitude scale 58 is a vertical scale.

As an optional addition, the display module 36 is further configured to display, at the altitude corresponding to the upper bound of the current displayed altitude range Alt_{range}, a secondary position scale 60, visible in FIGS. 4 and 5. In other words, the secondary position scale 60 is displayed at the maximum altitude of the current displayed altitude range Alt_{range}. This position scale 60 then makes it possible to best visually delimit an upper border, or upper boundary, of the current displayed altitude range Alt_{range}. The secondary position scale 60 is a horizontal scale.

As another optional addition, the display module 36 is configured to display the secondary position scale 60 only during the display of a second respective symbol 52 associated with a corresponding reference altitude Z_{ref} above the current displayed altitude range Alt_{range}, as shown in FIG. 4. The second symbol 52 is then displayed in contact with the secondary position scale 60. The display of the secondary position scale 60 according to this optional addition then makes it possible to make the display of the second symbol 52 more intelligible for the user in the high configuration, i.e., the configuration in which the corresponding reference altitude Z_{ref} is above the current displayed altitude range Alt_{range}.

As a variant of this optional addition, the display module 36 is configured to display the secondary position scale 60 during the display of a second respective symbol 52, irrespective of whether the associated reference altitude Z_{ref} is above or below the current displayed altitude range Alt_{range}, as shown in FIG. 5. The display of the secondary position scale 60 when a respective second symbol 52 is displayed then better makes it possible to attract the user's attention, so that he more quickly perceives the display of said second symbol 52, whether it is in the high configuration or the low configuration, i.e., the configuration in which the corresponding reference altitude Z_{ref} is below the current displayed altitude range Alt_{range}.

As still another variant of this optional addition, the display module 36 is configured to display the secondary position scale 60 at all times.

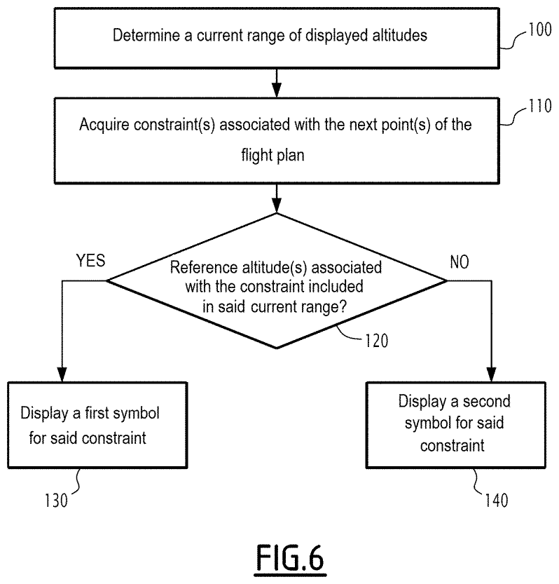

The operation of the electronic management device 20 will now be explained using FIG. 6, showing a flowchart of the method, according to the invention, for managing the display of a flight profile 14, 16 of the aircraft 12, in particular the vertical flight profile 14, the method being implemented by the management device 20.

During an initial step 100, the management device 20 determines, via its determining module 30, the current range of altitudes Alt_{range} displayed when displaying a vertical flight profile 14.

The management device 20 acquires, during step 110 and via its acquisition module 32, at least one constraint C1, C2, C3, C4 associated with an upcoming point of a flight plan.

During the following step 120, the management device 20 tests, via its test module 34, whether the reference altitude(s) associated with a respective constraint C1, C2, C3, C4 are included in the current displayed altitude range Alt_{range}.

When a respective reference altitude Z_{ref} is included in the current displayed altitude range Alt_{range}, the management device 20 then displays, during step 130 and via its display module 36, a first symbol 50 representative of the constraint C1, C2, C3, C4 for said reference altitude Z_{ref} included in the current displayed altitude range Alt_{range}.

Otherwise, when a respective reference altitude Z_{ref} is not included in the current displayed altitude range Alt_{range}, the management device 20 then displays, during step 140 and via its display module 36, a second symbol 52 representative of the constraint C1, C2, C3, C4 for said reference altitude Z_{ref} not included in the current displayed altitude range Alt_{range}.

FIGS. 4 and 5 then illustrate examples of views of the vertical flight profile 14, displayed on the vertical display VD in flight plan mode.

In FIG. 4, the current displayed altitude range Alt_{range} substantially corresponds to the range from 0 feet to 7500 feet, the reference altitude Z_{ref} associated with the constraint for the waypoint QN846 that is equal to 4000 feet is therefore included in said current displayed altitude range Alt_{range} such that the constraint for the waypoint QN846 is represented by a corresponding first symbol 50. The same is true for the constraint for the waypoint QN849 with a reference altitude Z_{ref} equal to 6000 feet and therefore included in the current displayed altitude range Alt_{range}.

The constraint for the waypoint LEGAR is a constraint C4 of the window type, for which the first reference altitude Z_{ref}, namely the minimum altitude, is equal to 4500 feet and included in the current displayed altitude range Alt_{range}, creating a representation by a corresponding first symbol 50; and the second reference altitude Z_{ref}, namely the maximum altitude, is equal to 11,000 feet and is not included in the current displayed altitude range Alt_{range}, creating a representation by a corresponding second symbol 52.

In FIG. 5, the current displayed altitude range Alt_{range} substantially corresponds to the range from 5500 feet to 13500 feet, the reference altitude Z_{ref} associated with the constraint for the waypoint EKVOX that is equal to 8000 feet is therefore included in said current displayed altitude range Alt_{range} such that the constraint for the waypoint EKVOX is represented by a corresponding first symbol 50.

Conversely, the constraint for the following waypoint at a reference altitude Z_{ref} equal to 4000 feet and is therefore not included in the current displayed altitude range Alt_{range} such that the constraint for this waypoint is represented by a corresponding second symbol 52.

Thus, with the electronic management device 20 according to the invention and the associated management method, although the constraint for the waypoint LEGAR is partially too high relative to the current displayed altitude range Alt_{range} in FIG. 4 or that for the last waypoint is too low relative to the current displayed altitude range Alt_{range} in FIG. 5, these two constraints are nevertheless displayed in the form of a respective second symbol 52, and then visible for the user.

On the contrary, in the same situation, these constraints for the waypoint LEGAR in FIG. 4 and for the last waypoint in FIG. 5 are not displayed with the management device of the state of the art.

With the electronic management device 20 according to the invention, the information relative to the constraint(s) C1, C2, C3, C4 is then displayed at all times in the form of a first symbol 50 and/or a second symbol 52, and the user does not need to modify his display settings, in particular the range of displayed altitudes, to view the constraints C1, C2, C3, C4.

Furthermore, with the electronic management device 20 according to the invention, there is no abrupt appearance or disappearance of a symbol representing a constraint C1, C2, C3, C4, but just a change of shape depending on whether the constraint C1, C2, C3, C4 is represented via a first symbol 50 and/or a corresponding second symbol 52.

One can thus see that the management method and the electronic management device 20 according to the invention make it possible to provide the user, such as the pilot of the aircraft 12, with more information relative to the flight plan.

1. A method for managing the display of a flight profile of an aircraft, the method being implemented by an electronic display management device and comprising the following steps:
determining a current range of altitudes displayed when displaying a vertical flight profile;
acquiring at least one constraint associated with an upcoming point of a flight plan, each constraint including at least one reference altitude;
when a respective reference altitude is not included in the current displayed altitude range, displaying a symbol representative of the constraint for said reference altitude not included in the current displayed altitude range,
wherein the symbol further includes additional signage representative of a prediction for realization of the constraint by the aircraft.

2. The method according to claim 1, wherein during the acquisition step, at least one constraint is a passage altitude constraint of the aircraft.

3. The method according to claim 2, wherein during the acquisition step, each constraint is a passage altitude constraint of the aircraft.

4. The method according to claim 1, wherein each constraint is chosen from the group consisting of: an at or above altitude, an at or below altitude, an at altitude and an altitude window.

5. The method according to claim 1, wherein when the respective reference altitude is not included in the current displayed altitude range:
if the respective reference altitude is above the current displayed altitude range, the symbol has a first shape; and
if the respective reference altitude is below the current displayed altitude range, the symbol has a second shape, different from the first shape.

6. The method according to claim 1, wherein during the display step, the symbol is displayed in the position of the constraint associated with said reference altitude not included in the current displayed altitude range.

7. The method according to claim 1, wherein during the display step:
if the respective reference altitude is above the current displayed altitude range, the symbol is displayed at the maximum altitude of the current displayed altitude range; and
if the respective reference altitude is below the current displayed altitude range, the symbol is displayed at the minimum altitude of the current displayed altitude range.

8. A non-transitory computer-readable medium including a computer program comprising software instructions which, when executed by a computer, carry out a method according to claim 1.

9. An electronic display management device configured to manage the display of a flight profile of an aircraft, comprising:
a determining module configured to determine a current range of altitudes displayed when displaying a vertical flight profile;
an acquisition module configured to acquire at least one constraint associated with an upcoming point of a flight plan, each constraint including at least one reference altitude;
a display module configured, when a respective reference altitude is not included in the current displayed altitude range, to display a symbol representative of the constraint for said reference altitude not included in the current displayed altitude range,
wherein the symbol further includes additional signage representative of a prediction for realization of the constraint by the aircraft.

10. An electronic system for displaying a flight profile of an aircraft, the system comprising a display screen and an electronic management device configured to manage the display of the flight profile on the display screen,
wherein the electronic management device is according to claim 9.

11. A method for managing the display of a flight profile of an aircraft, the method being implemented by an electronic display management device and comprising the following steps:
determining a current range of altitudes displayed when displaying a vertical flight profile;
acquiring at least one constraint associated with an upcoming point of a flight plan, each constraint including at least one reference altitude;
when a respective reference altitude is not included in the current displayed altitude range, displaying a symbol representative of the constraint for said reference altitude not included in the current displayed altitude range,
wherein when the respective reference altitude is not included in the current displayed altitude range:
if the respective reference altitude is above the current displayed altitude range, the symbol has a first shape; and
if the respective reference altitude is below the current displayed altitude range, the symbol has a second shape, different from the first shape.

12. A non-transitory computer-readable medium including a computer program comprising software instructions which, when executed by a computer, carry out a method according to claim 11.

13. An electronic display management device configured to manage the display of a flight profile of an aircraft, comprising:
a determining module configured to determine a current range of altitudes displayed when displaying a vertical flight profile;
an acquisition module configured to acquire at least one constraint associated with an upcoming point of a flight plan, each constraint including at least one reference altitude;
a display module configured, when a respective reference altitude is not included in the current displayed altitude range, to display a symbol representative of the constraint for said reference altitude not included in the current displayed altitude range,
wherein when the respective reference altitude is not included in the current displayed altitude range:
if the respective reference altitude is above the current displayed altitude range, the symbol has a first shape; and
if the respective reference altitude is below the current displayed altitude range, the symbol has a second shape, different from the first shape.
